(19) United States
(12) Patent Application Publication
(10) Pub. No.: US 2006/0088131 A1
(43) Pub. Date: Apr. 27, 2006

(54) SLICER APPARATUS AND METHOD FOR GENERATING SLICER OUTPUT VALUES

(76) Inventors: Tsu-Chun Liu, Hsinchu (TW); Ming-Lu Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,580

(22) Filed: Feb. 25, 2005

(30) Foreign Application Priority Data
Oct. 27, 2004 (TW) 93132506

(51) Int. Cl. H04L 27/06

(52) U.S. Cl. 375/340

(57) ABSTRACT

A method and an apparatus for reducing the area and shortening the critical path of Viterbi circuits in Gigabit Ethernet systems. The present invention replaces the complex four-dimensional Euclidean distance with a simple sum of distances in each dimension as the distance criterion when a slicer is selecting the closest PAM-5 constellation point according to output voltages from an equalizer, thereby simplifying the design of Viterbi circuits.

### CROSS-REFERENCE TO RELATED APPLICATION

This application claims the priority benefit of Taiwan application serial no. 93132506, filed on Oct. 27, 2004.

### BACKGROUND OF THE INVENTION

1. Field of the Invention

The present invention relates to a digital signal transmitting and receiving technique for Gigabit Ethernet systems, and more particularly, to a technique for selecting the closest PAM-5 constellation point according to output voltages from an equalizer.

2. Description of the Related Art

Currently, four-dimensional pulse amplitude modulation-5 (abbreviated as PAM-5 hereinafter) technique is used by Gigabit Ethernet systems for encoding data. Each time before a data word is transmitted by a network system, the data word is encoded firstly for mapping it to a set of four PAM-5 voltage values. Wherein, each PAM-5 voltage value may be a value selected from a set of {−1, −0.5, 0. 0.5, 1} as a unit of voltage. For example, one of the possible encoding results may be {0.5, −0.5, 1, 0}. Then, these four voltage signals are transmitted through an unshielded twisted pair respectively, and finally a set of four PAM-5 voltage signals is received by a network system in the receiver site.

In an ideal case, the set of voltage signals received by the network system in the receiver site is identical with the set of voltage signals transmitted by the transmitter site. However, after the signals are transmitted, the signals are inevitably impacted by various adverse factors such as echo, crosstalk, attenuation, distortion, or inter-symbol interference of the voltage signals in physical environment. In order to recover the voltage signals received in the receiver site, an equalizer is commonly used to eliminate the adverse factors applied on the signals, and a slicer is used to determine a set of PAM-5 voltage values which is closest to the received signals, and then the set of PAM-5 voltage values is decoded as a received data word. Wherein, a Viterbi circuit is commonly used in the slicer for determining the process mentioned above.

Please refer to FIG. 1 for a method of selecting a closest set of PAM-5 voltage values by the Viterbi circuit. A combination of all possible PAM-5 voltage values can be represented by a four-dimensional array that indicates a set of four voltage values, wherein each dimension has five points that indicate five possible voltage values. Therefore, a 5×5×5×5 four dimensional array is obtained. For a better understanding, the four dimensional array is represented as a two-dimensional array 104 as shown in FIG. 1.

Assuming an output of the equalizer is a point 101 located in the array 104, with the conventional technique, a closest PAM-5 voltage values constellation point 102 is selected by the Viterbi circuit by using the Euclidean distance as a criterion for determining the level of closeness. A right-angled triangle 103 in FIG. 1 schematically shows a correlated position of magnified points 101 and 102. If the distance between these two points in the 0th dimension is |a|, and the distance between these two points in the 1st dimension is |b|, the Euclidean distance |c| between these two points is equal to the square root of (a2+b2).

Since calculation of Euclidean distance |c| is based on a square and square root operation, a more complicated and large circuit is required for its operation. In addition, the total elapse time from receiving, determining, decoding, and recovering of a set of voltage signals in Gigabit Ethernet systems should be less than 8 nanoseconds. In order to complete this complicated square and square root operation in an extremely short time period, the requirement of the circuit design is strict and the manufacturing cost is inevitably increased.

Therefore, a technique of simplifying circuit design by simplifying the determination process is demanded; with such technique, the manufacturing cost of circuit is effectively reduced.

### SUMMARY OF THE INVENTION

Therefore, an object of the present invention is to provide a slicer apparatus for simplifying the circuit, reducing the area, and shortening the critical path of Viterbi circuit in Gigabit Ethernet systems.

Another object of the present invention is to provide a method for generating slicer output values for simplifying the circuit, reducing the area, and shortening the critical path of Viterbi circuit in Gigabit Ethernet systems.

In order to achieve the objects mentioned above and others, a slicer apparatus is provided by the present invention. First, the slicer apparatus receives a set of input voltage values. Next, a plurality of slicer output reference value generating apparatuses provide slicer output reference values, then a sum of the distances in each dimension between each slicer output reference value and the point corresponding to the input voltage values is calculated by the same number of the distance calculating apparatus, and finally a slicer output reference value having minimum sum of distances in each dimension is selected by a comparing/selecting apparatus as an output of the slicer apparatus.

The present invention further provides a slicer apparatus. First, the slicer apparatus receives a set of input voltage values. Second, two slicer output reference value generating apparatus provide two slicer output reference values, then a sum of the distances in each dimension between the first slicer output reference value and the point corresponding to the input voltage values is calculated by a distance calculating apparatus, and finally a slicer output reference value is selected from comparing the sum of distances in each dimension mentioned above with a predetermined constant by a comparing/selecting apparatus as an output of the slicer apparatus.

A method for generating slicer output values is further provided by the present invention. The method comprises the following steps. First, a set of input voltage values and a plurality of slicer output reference values are received. Then, a sum of distances in each dimension between each of the slicer output reference values and the point corresponding to the input voltage values is calculated. Finally, a slicer output reference value having minimum sum of distances in each dimension is selected as an output value of the slicer apparatus.

A method for generating slicer output values is further provided by the present invention. The method comprises the following steps. First, a set of input voltage values and two slicer output reference values are received. Then, a sum of distances in each dimension between the first slicer output reference value and the point corresponding to the input voltage values is calculated. Finally, a slicer output reference value is selected from comparing the sum of distances in each dimension mentioned above with a predetermined constant as an output of the slicer apparatus.

In accordance with a preferred embodiment of the present invention, the major improvement of the present invention is replacing the complex four-dimensional Euclidean distance with a simple sum of distances in each dimension as the distance criterion when a slicer is selecting the closest PAM-5 constellation point according to output voltages from an equalizer, such that the design of Viterbi circuits is simplified and the complicated square and square root calculation are eliminated.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a PAM-5 voltage value array for describing the slicer operation.

FIG. 2A schematically shows the output values provided by the X-type slicer.

FIG. 2B schematically shows the output values provided by the Y-type slicer.

FIGS. 3A and 3B are the diagrams for describing a certain condition.

FIG. 4 schematically shows an embodiment of a slicer apparatus provided by the present invention.

FIG. 5 schematically shows an embodiment of another slicer apparatus provided by the present invention.

FIG. 6 schematically shows a flow chart illustrating an embodiment of a method for generating slicer output values provided by the present invention.

FIG. 7 schematically shows a flow chart illustrating an embodiment of another method for generating slicer output values provided by the present invention.

### DESCRIPTION OF THE PREFERRED EMBODIMENTS

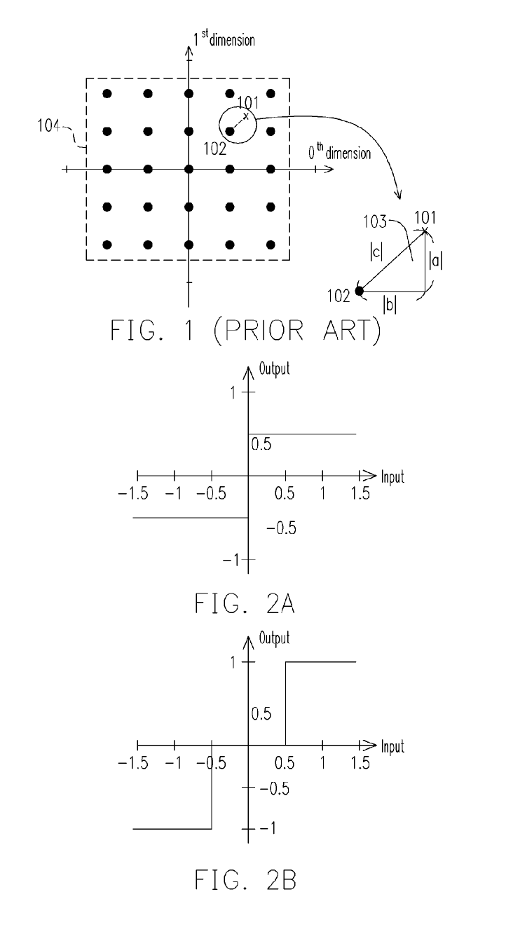

First, two types of circuit apparatus served for basic operation apparatus including X-type slicer and Y-type slicer are described. Both slicers receive an input voltage and generate an output voltage. Wherein, the output values provided by the X-type slicer are “0.5” and “−0.5” as shown in FIG. 2A, and the output values provided by the Y-type slicer are “1”, “0”, and “−1” as shown in FIG. 2B.

Two values including X-branch and Y-branch are predefined for further explanation. Here, the X-branch for any voltage value V is defined as:
|V—(output value obtained by the X-type slicer when V is input)|

Wherein, ∥ represents an absolute value. Similarly, the Y-branch of V is defined as:
|V—(output value obtained by the Y-type slicer when V is input)|

The following conditions are described first for explaining subsequent embodiments.

For any voltage value V, if −1≦V≦1, the sum of the X-branch of V and the Y-branch of V is always equal to 0.5.

Herein, in order to prove this theory, V is divided into 4 ranges as [−1, −0.5], [−0.5, 0], [0, 0.5], and [0.5, 1].

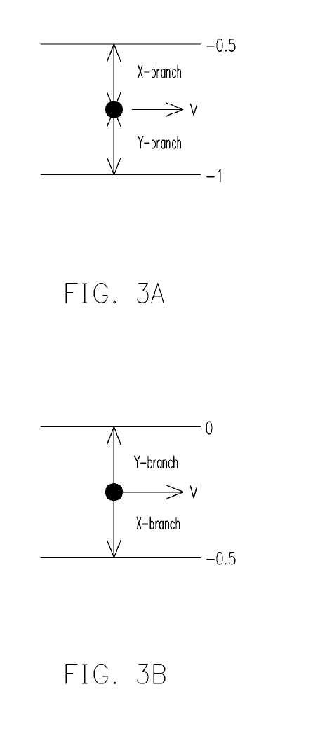

Please refer to FIG. 3A to prove the theory in the first range. Herein, the X-branch of V is |V−(−0.5)|, i.e. −0.5−V, and the Y-branch of V is |V−(−1)|, i.e. V+1, thus the sum of these two values is 0.5.

Please refer to FIG. 3B to prove the theory in the second range. Herein, the X-branch of V is |V−(−0.5)|, i.e. V+0.5, and the Y-branch of V is |V|, i.e. −V, thus the sum of these two values is 0.5.

The proof of the theory in the third and fourth ranges are essentially symmetric to the previous two ranges, thus the details are omitted herein. In summary, the theory mentioned above is validly sustained from the four ranges stated above. According to the PAM-5 encoding method, any encoded voltage value V should be satisfied with the condition of −1≦V≦−1. In other words, it is suitable for applying the theory mentioned above.

In Gigabit Ethernet systems, the data word to be transmitted is encoded to PAM-5 voltage values with trellis encoding, and the encoded values are recovered with Viterbi decoding. Wherein, a Viterbi circuit in the slicer is responsible for Viterbi decoding. The trellis encoding divides five PAM-5 voltage values into two sets, wherein one is {−0.5, 0.5}, which is the output values provided by the X-type slicer and referred to as X set; the other set is {−1, 0, 1}, which is the output values provided by the Y-type slicer and referred to as Y set. If a set of PAM-5 voltage values is regarded as a point in the four-dimensional space, each single coordinate value can be divided into X, Y two types, thus there are 16 types of the X, Y combination in total from four coordinate values. The trellis encoding further combines the 16 combinations mentioned above into 8 subsets, wherein each subset includes two secondary subsets, and each secondary subset corresponds to one of the X, Y combinations mentioned above. The union of the subsets represents all corresponding points in four-dimensional space for all possible PAM-5 voltage values. The 8 subsets used in the trellis encoding are shown in the table below.

| Subset | Content |
|---|---|
| S0 | XXXX ∪ YYYY |
| S1 | XXXY ∪ YYYX |
| S2 | XXYY ∪ YYXX |
| S3 | XXYX ∪ YYXY |
| S4 | XYYX ∪ YXXY |
| S5 | XYYY ∪ YXXX |
| S6 | XYXY ∪ YXYX |
| S7 | XYXX ∪ YXYY |

In Viterbi decoding, a step is included to select a slicer output reference value closer to the output voltage value provided by the equalizer among two slicer output reference values which are correspondingly generated by one of the subsets, and the dimensional coordinates of the slicer output reference value are the PAM-5 voltage values required for decoding. The so-called “close” herein is based on a space distance that is different from a Euclidean distance used in the conventional technique. The sum of coordinate difference in each dimension in the present invention is referred hereinafter as a sum of distances in each dimension. A subset S4 shown in the above table is exemplified herein for explaining the “slicer output reference values”, wherein the first slicer output reference value is a PAM-5 corresponding point closest to the voltage value provided by the equalizer among the secondary subset XYYX, the second slicer output reference value is a PAM-5 corresponding point closest to the voltage value provided by the equalizer among the secondary subset YXXY, and so on. This step is used in the method and apparatus provided by the present invention, and the subset S4 is exemplified in the subsequent embodiments for explanation.

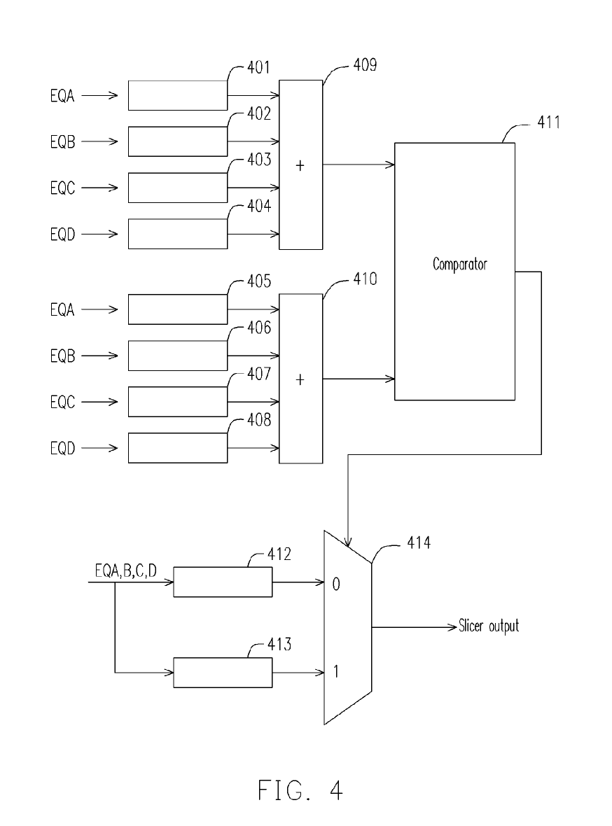

A slicer apparatus is provided by the present invention, and FIG. 4 schematically shows an embodiment of the slicer apparatus. A set of four voltage values {EQA, EQB, EQC, and EQD} is provided by an equalizer which is not shown in the diagram as inputs of the slicer apparatus. The slicer apparatus first calculates two slicer output reference values corresponded to the input voltage values in the subset S4, and then calculates a sum of the distances in each dimension between two slicer output reference values and corresponding point of the input voltage values, respectively, so as to select a slicer output reference value having a smaller sum in each dimension as an output of the slicer apparatus.

First, two slicer output reference values mentioned above are calculated by the slicer output reference value generating apparatus 412 and 413. Wherein, the output of the slicer output reference value generating apparatus 412 is one of the results, which is the result of X-type slicer when EQA is input to it, result of Y-type slicer when EQB is input to it, result of Y-type slicer when EQC is input to it, or the result of X-type slicer when EQD is input to it, and the output of the slicer output reference value generating apparatus 413 is one of the results, which is the result of Y-type slicer when EQA is input to it, result of X-type slicer when EQB is input to it, result of X-type slicer when EQC is input to it, or the result of Y-type slicer when EQD is input to it. Then, the outputs of the slicer output reference value generating apparatus 412 and 413 are provided to a multiplexer 414 as a selection criterion.

Afterward, an X-branch of EQA is calculated by a calculating apparatus 401, a Y-branch of EQB is calculated by a calculating apparatus 402, a Y-branch of EQC is calculated by a calculating apparatus 403, and an X-branch of EQD is calculated by a calculating apparatus 404. Then, an adder 409 summates the calculation results of the calculating apparatus 401 to 404, and provides a sum to a comparator 411 for further comparison. Wherein, the output of the adder 409 is the sum of distances in each dimension between one of the slicer output reference values and the point corresponding to the voltage values provided by the equalizer mentioned above.

Then, the same method is applied to another slicer output reference value, wherein a Y-branch of EQA is calculated by a calculating apparatus 405, an X-branch of EQB is calculated by a calculating apparatus 406, an X-branch of EQC is calculated by a calculating apparatus 407, and a Y-branch of EQD is calculated by a calculating apparatus 408. Then, an adder 410 summates the calculation results of the calculating apparatus 405 to 408, and provides a sum to the comparator 411 for further comparison.

Finally, the comparator 411 compares the output of the adder 409 with the output of the adder 410, and provides a comparison result to the multiplexer 414 as a selection criterion. If the output of the adder 409 is greater than the output of the adder 410, the output of the slicer output reference value generating apparatus 413 is selected as the output of the slicer apparatus. Otherwise, the output of the slicer output reference value generating apparatus 412 is selected as the output of the slicer apparatus.

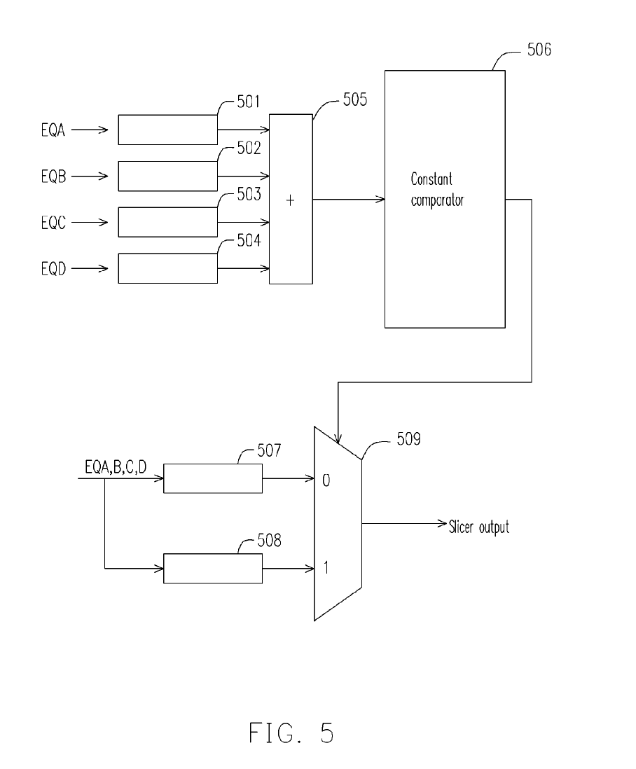

FIG. 5 schematically shows an embodiment of another slicer apparatus provided by the present invention. Different from the slicer apparatus of FIG. 4, the slicer apparatus in FIG. 5 only calculates a sum of distances in each dimension between one of the slicer output reference values and the point corresponding to the voltage values provided by the equalizer, and then compares the sum with a constant 1, so as to select one slicer output reference value among two slicer output reference values as the output of the slicer apparatus.

The slicer apparatus of FIG. 5 calculates the sum of distances in each dimension of one of the slicer output reference values based on the condition mentioned above. In FIG. 4, the output of the adder 409 is X-branch of EQA+Y-branch of EQB+Y-branch of EQC+X-branch of EQD; and the output of the adder 410 is Y-branch of EQA+X-branch of EQB+X-branch of EQC+Y-branch of EQD. After the output of the adder 409 is summated with the output of the adder 410 and the theory mentioned above is applied on it, it is known that the sum of the outputs of two adders is always equal to 2. Therefore, if the output of the adder 409 is greater than 1, the output of the adder 410 should be less than 1, that is the output of the adder 409 is always greater than the output of the adder 410. Accordingly, the comparison performed by a constant comparator 506 of FIG. 5 has the same effect as the result of the comparator 411 of FIG. 4, and the slicer apparatus of FIG. 5 performs the same function as the slicer apparatus of FIG. 4.

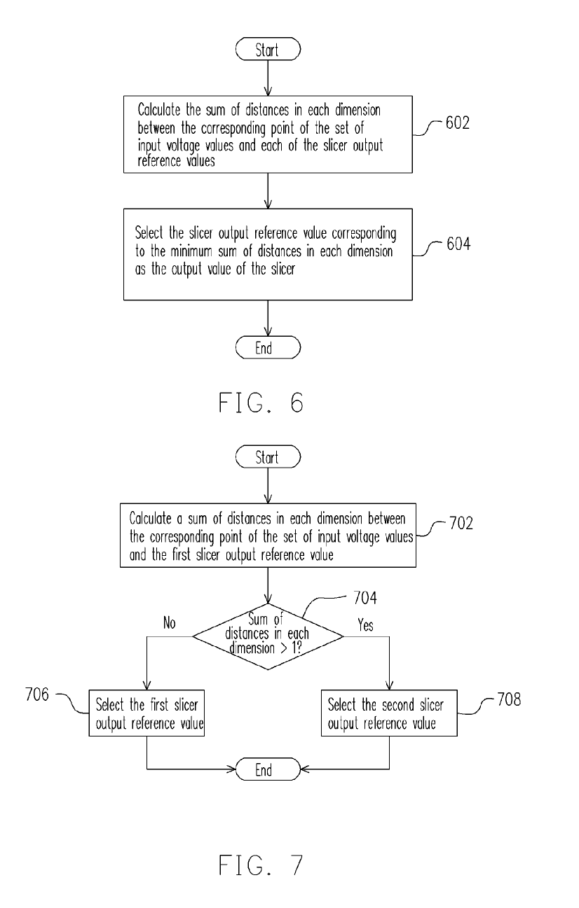

Another method for generating slicer output values is further provided by the present invention, and FIG. 6 schematically shows a flow chart of its embodiment. First, a set of input voltage values provided by the equalizer and two slicer output reference values are received. Then, in step 602, a sum of the distances in each dimension between each slicer output reference value and the point corresponding to the input voltage values is calculated. Finally, in step 604, a slicer output reference value having smaller sum of distances in each dimension is selected between two slicer output reference values as the output of the slicer apparatus in the present method.

Another method for generating slicer output values is further provided by the present invention, and FIG. 7 schematically shows a flow chart of its embodiment. First, a set of input voltage values provided by the equalizer and two slicer output reference values are received. Wherein, these two slicer output reference values belong to the same subset used in the trellis encoding, and the first slicer output reference value is from a first secondary subset contained in this subset, whereas the second slicer output reference value comes from a second secondary subset contained in this subset. Then, in step 702, a sum of the distances in each dimension between the first slicer output reference value and the point corresponding to the input voltage values is calculated. In step 704, it is determined whether the sum of distances in each dimension obtained from calculation is greater than 1 or not. If it is, the process goes to step 708 where the second slicer output reference value is selected. Otherwise, the process goes to step 706 where the first slicer output reference value is selected. The selected slicer output reference value is the output of the slicer apparatus generated by the present method. It is known from the condition mentioned above that the present method has the same effect as the previous slicer output value generating method.

An example is exemplified herein for describing in details of the apparatus and method provided by the present invention. It is assumed that the voltage values provided by the equalizer are {0.1, 0.8, 06, −0.2}, the XYYX reference values in subset S4 are {0.5, 1, 1, −0.5}, and the sum of distances in each dimension from the point corresponding to the output voltage values is 0.4+0.2+0.4+0.3=1.3. In addition, the YXXY reference values in subset S4 is {0, 0.5, 0.5, 0}, and the sum of distances in each dimension from the point corresponding to the output voltage values is 0.1+0.3+0.1+0.2=0.7. Therefore, the YXXY reference value which is closer should be selected, and its coordinate {0, 0.5, 0.5, 0} is the final PAM-5 voltage values for decoding.

It is known from descriptions and examples mentioned above, the apparatus and method provided by the present invention is able to select a slicer output reference value which is closest to the voltage value provided by the equalizer by merely calculating a sum in each dimension without having to calculate the complicated four-dimensional Euclidean distance. Therefore, the complicated square and square root calculation is avoided and the object of simplifying the Viterbi circuit is achieved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A slicer apparatus, comprising:
a plurality of slicer output reference value generating apparatuses for receiving a set of n input voltage values from outside and generating a plurality of slicer output reference values, respectively;
a plurality of distance calculating apparatuses, wherein a quantity of the distance calculating apparatuses is the same as a quantity of the slicer output reference value generating apparatuses, and there is a one-to-one corresponding relationship between the distance calculating apparatuses and the slicer output reference value generating apparatuses, each of the distance calculating apparatus receiving the set of n input voltage values, calculating a sum of distances in each dimension between a corresponding point of the set of n input voltage values in an n-dimensional space and the slicer output reference value corresponding to the distance calculating apparatus, and providing the sum of distances in each dimension; and
a comparing/selecting apparatus, coupled to the distance calculating apparatuses for comparing the sums of distances in each dimension and obtaining a minimum sum of distances in each dimension, and selecting the slicer output reference value corresponding to the minimum sum of distances in each dimension as an output of the slicer apparatus.

2. The slicer apparatus of claim 1, wherein n is equal to 4.

3. The slicer apparatus of claim 1, wherein a range of each voltage value V contained in the set of n input voltage values is −1 volt≦V≦1 volt.

4. The slicer apparatus of claim 1, wherein the quantity of the slicer output reference value generating apparatus is 2, and the quantity of the distance calculating apparatus is 2.

5. The slicer apparatus of claim 4, wherein the two slicer output reference values provided by the slicer output reference value generating apparatus belong to a subset used in trellis encoding, and belong to two secondary subsets contained in the subset, respectively.

6. The slicer apparatus of claim 5, wherein each of the slicer output reference value generating apparatus receives the set of n input voltage values, and provides, among all slicer output reference values contained in the secondary subset corresponding to the slicer output reference value generating apparatus, the slicer output reference value with the minimum sum of distances in each dimension from the point corresponding to the set of n input voltage values as an output of the slicer output reference value generating apparatus.

7. A slicer apparatus, comprising:
a first slicer output reference value generating apparatus for receiving a set of n input voltage values and generating a first slicer output reference value;
a second slicer output reference value generating apparatus for receiving the set of n input voltage values and generating a second slicer output reference value, both the first slicer output reference value and the second slicer output reference value belonging to a subset used in trellis encoding, wherein the first slicer output reference value is, among all slicer output reference values contained in the first secondary subset of the subset, the slicer output reference value with the minimum sum of distances in each dimension from the point corresponding to the set of n input voltage values, and the second slicer output reference value is, among all slicer output reference values contained in the second secondary subset of the subset, the slicer output reference value with the minimum sum of distances in each dimension from the point corresponding to the set of n input voltage values;
a distance calculating apparatus for receiving the set of n input voltage values, calculates a sum of distances in each dimension between the corresponding point of the set of n input voltage values in an n-dimensional space and the first slicer output reference value, and providing the sum of distances in each dimension; and
a comparing/selecting apparatus, coupled to an output of the distance calculating apparatus for comparing the output of the distance calculating apparatus with (n×0.5)/2, if the output of the distance calculating apparatus is greater than (n×0.5)/2, selecting the second slicer output reference value as an output of the slicer apparatus, if the output of the distance calculating apparatus equals to (n×0.5)/2, selecting the first slicer output reference value as the output of the slicer apparatus, and if the output of the distance calculating apparatus is less than (n×0.5)/2, selecting the first slicer output reference value as the output of the slicer apparatus.

8. The slicer apparatus of claim 7, wherein n is equal to 4.

9. A method for generating slicer output values, comprising:
providing a set of n input voltage values;
providing a plurality of slicer output reference values existing in an n-dimensional space;
calculating a sum of distances in each dimension between the corresponding point of the set of n input voltage values in the n-dimensional space and each of the slicer output reference values, respectively; and
selecting the slicer output reference value corresponding to the minimum sum of distances in each dimension as an output value of the slicer.

10. The method for generating the slicer output value of claim 9, wherein n is equal to 4.

11. The method for generating the slicer output value of claim 9, wherein a range of each voltage value V contained in the set of n input voltage values is −1 volt≦V≦1 volt.

12. The method for generating the slicer output value of claim 9, wherein the quantity of the slicer output reference values is 2.

13. The method for generating the slicer output value of claim 12, wherein the slicer output reference values belong to a subset used in trellis encoding, and also belong to two secondary subsets of the subset, respectively.

14. The method for generating the slicer output value of claim 13, wherein each of the slicer output reference values is, among all slicer output reference values contained in the corresponding secondary subset, the slicer output reference value with the minimum sum of distances in each dimension from the point corresponding to the set of n input voltage values.

15. A method for generating slicer output values, comprising:
providing a set of n input voltage values;
providing a first slicer output reference value and a second slicer output reference value, wherein both the first slicer output reference value and the second slicer output reference value exist in an n-dimensional space and belong to a subset used in trellis encoding, the first slicer output reference value is, among all slicer output reference values contained in the first secondary subset of the subset, the slicer output reference value with the minimum sum of distances in each dimension from the point corresponding to the set of n input voltage values, and the second slicer output reference value is, among all slicer output reference values contained in the second secondary subset of the subset, the slicer output reference value with the minimum sum of distances in each dimension from the point corresponding to the set of n input voltage values;
calculating a sum of distances in each dimension between the corresponding point of the set of n input voltage values in the n-dimensional space and the first slicer output reference value; and
comparing the sum of distances in each dimension with (n×0.5)/2, if the sum of distances in each dimension is greater than (n×0.5)/2, selecting the second slicer output reference value as an output value of the slicer apparatus, if the sum of distances in each dimension equals to (n×0.5)/2, selecting the first slicer output reference value as the output value of the slicer apparatus, and if the sum of distances in each dimension is less than (n×0.5)/2, selecting the first slicer output reference value as the output value of the slicer apparatus.

16. The method for generating the slicer output value of claim 15, wherein n is equal to 4.
